(19) United States
(12) Patent Application Publication
(10) Pub. No.: US 2013/0067712 A1
(43) Pub. Date: Mar. 21, 2013

(54) METHOD FOR ALIGNING CROSSVIEW MIRRORS

(71) Applicant: William P. Schmidt, Newport, MI (US)

(72) Inventor: William P. Schmidt, Newport, MI (US)

(21) Appl. No.: 13/315,656

(22) Filed: Dec. 9, 2011

Related U.S. Application Data
(63) Continuation-in-part of application No. 11/506,123, filed on Aug. 17, 2006, now abandoned.

(51) Int. Cl. G02B 7/182

(52) U.S. Cl. CPC G02B 7/182
USPC 29/407.09

(57) ABSTRACT

A remote controlled crossview mirror assembly for use on a vehicle that allows a vehicle operator to adjust an arcuate mirror to improve the field of vision directly in front of and to the sides of the vehicle. To operate the assembly, the operator activates an electronic controller contained within the cab region. The electronic controller sends an electrical signal to an electronic actuator. The electronic actuator interprets the electronic signal and rotates about a center point thereby adjusting a coupled arcuate mirror to improve the operator's field of vision directly in front of and to the sides of the vehicle.

### CROSS REFERENCE TO RELATED APPLICATIONS

This is a continuation-in-part of U.S. patent application Ser. No. 11/506,123 filed on Aug. 17, 2006.

### TECHNICAL FIELD

The present invention relates generally to methods for adjusting and aligning mirror assemblies and more particularly to methods for accurately adjusting crossview bus mirrors.

### BACKGROUND OF THE INVENTION

Today, mirrors are used in a variety of applications such as astronomy, space ships, solar devices, vehicles, microscopes, satellite communication devices and medicine. One of the best-known applications for mirrors are for motor vehicles.

Motor vehicles require mirrors in order to provide the driver or operator of the vehicle, the widest possible field of view around his vehicle. This is done for safety purposes since most vehicles, due to structural obstructions, have “blind spots” which prevent the driver from seeing any object that may come near the front, rear or sides of the vehicle. Vehicle mirrors typically are mounted externally at the sides of the vehicles to enhance the field of view of the driver, particularly along the sides and at the rear of the vehicle. These are called “rear view mirrors” or “driving mirrors”.

Mirrors for vehicles are shown, for example, in U.S. Pat. Nos. 2,969,715, 2,778,273, 2,911,177, 3,104,274, 3,170,985, 3,389,952 and 3,003,396. Some of the mirrors disclosed in these patents are mounted on the inside of the vehicles, but most are mounted exteriorly on the sides of the vehicles as rear view mirrors. These mirrors are commonly used on trucks and automobiles.

Mirrors for school buses are different. Not only must school buses have side rear view mirrors (“driving mirrors”), but Federal law, particularly Section 571.111 of the Federal Motor Vehicle Safety Standards (FMVSS), requires school buses to have crossview mirrors as well. The side rear view mirrors are commonly referred to as the “driving mirrors” because they are used by the bus drivers when the buses are in motion and being driven by the drivers. Crossview mirrors are mirrors which are positioned on the front corners of the school buses and are used to provide visual access of the “blind” areas in the front of the buses and along the side which has the passenger access door. Crossview mirrors are used when the bus is at rest and the school children are getting on or off the bus.

Prior to the use of crossview mirrors, none of the prior vehicle mirrors were successfully employed on school buses to effectively reduce “blind spots” particularly those in the front of the buses. The National Safety Council reported 58,000 annual school bus accidents occurring nationally in 1977 and 1978 and approximately 165 fatalities per year. A Kansas Department of Transportation study of these national school bus fatalities pinpointed the contributing factors. From 1975 through 1978, 73 percent of the fatalities were among homeward bound pupils; 60 percent of the pupils were killed by the bus itself; and 47 percent were 5 and 6 years old. These statistics clearly indicated that enhancing the bus driver's view in front of and around the buses could reduce these fatalities.

Crossview mirrors have significantly reduced the number of deaths and injuries to children who ride school buses. Proper positioning and alignment of the crossview mirrors is important to provide the best means to the driver of the situation around the front and sides of the buses. Under FMVSS §571.111, the crossview mirrors must be orientated and adjusted in a certain manner to provide an optimum field of view for the bus drivers. Also, the positioning of the mirrors must be continuously checked on a regular basis, and realigned and readjusted where necessary, to insure that they continue to be properly aligned and the field of view continues to be within the specified parameters.

Crossview mirrors are initially adjusted by the bus manufacturers before the buses are shipped to the local school districts or other users. Thereafter, for safety of the school children, the crossview mirrors need to be checked and readjusted by the bus owners on a virtual daily basis to make sure they still are in compliance with the FMVSS standards.

Presently, the adjustments and realignments of crossview mirrors on school buses at the school districts are accomplished manually. This is a time consuming task and requires two people—a first person (typically a driver) sitting in the driver's seat inside the bus, and a second person standing outside the bus and manually adjusting the mirrors as instructed by the first person. Preferably, this process is repeated and the crossview mirrors adjusted preceding each time the buses are driven.

Moreover, it is not uncommon for crossview mirrors to become misaligned during use of the bus, such as by contact with bushes or branches, or by being jarred out of alignment by rough road surfaces. Misalignment could also occur intentionally or unintentionally by the school children. If the mirrors become misaligned in any manner, and are not adjusted properly before the buses are driven again, then blind spots may occur in front of, or along the sides of, the vehicles, or the fields of view may be compromised. This creates dangerous situations for school children having to ride those buses.

### SUMMARY OF THE INVENTION

It is therefore an object of the present invention to provide an easier and improved method for adjusting crossview mirrors on school buses and maintaining proper alignment under the standards of the FMVSS.

The present invention addresses these objects by providing electronically controlled crossview mirrors controllable by a single person (driver) from inside the cab of the vehicle. An electronic controller preferably mounted in the cab region of the vehicle coupled to actuators within the crossview mirrors allows the mirrors to be adjusted around both the horizontal and vertical axes, or only horizontally around just a vertical axis. This allows the mirrors to be adjusted according to the operator's visual sightlines and ensure the minimization of blind spots in front of and along the sides of the vehicle. The crossview mirrors can be checked by a single person at any time, particularly before the bus is driven, and the mirror alignment can be adjusted to insure compliance with the Federal Standards.

The buses can be driven onto a FMVSS alignment grid so that the visual images from the crossview mirrors can be checked by a single person and any misalignments corrected individually. This can be done quickly and easily on a daily basis by the bus drivers.

Other objects, features, and advantages of the present invention will become apparent upon considering the following detailed description and appended claims, and upon reference to an accompanying drawings.

### BRIEF DESCRIPTION OF THE DRAWINGS

FIG. 1 is a perspective view of a school bus having a mirror assembly according to one embodiment of the present invention.

FIG. 2 illustrates an FMVSS alignment grid used for adjusting school bus crossview mirrors.

FIG. 3 is a perspective view of a mirror assembly according to an embodiment of the present invention.

FIG. 4 is a section view of the mirror assembly of FIG. 3 in the direction of the arrow 4-4 in FIG. 3.

FIG. 5 is a sectional view from the front of a mirror assembly according to an embodiment of the present invention.

FIG. 6 is a cross-sectional view of the mirror assembly of FIG. 5 in the direction of the arrows 6-6 in FIG. 5, along with an exemplary controller mechanism.

FIG. 7 is a cross-sectional view of a mirror adjustment mechanism according to another embodiment of the present invention.

### DETAILED DESCRIPTION OF THE PREFERRED EMBODIMENTS

For the purpose of promoting and understanding the principles of the present invention, reference will now be made to the embodiments illustrated in the drawings and specific language will be used to describe them. It will nevertheless be understood that no limitation as to the scope of the invention is hereby intended. The invention includes any alternatives and other modifications in the illustrated devices and described methods and further applications of the principles of the invention which would normally occur to persons or ordinary skill in the art to which the invention relates.

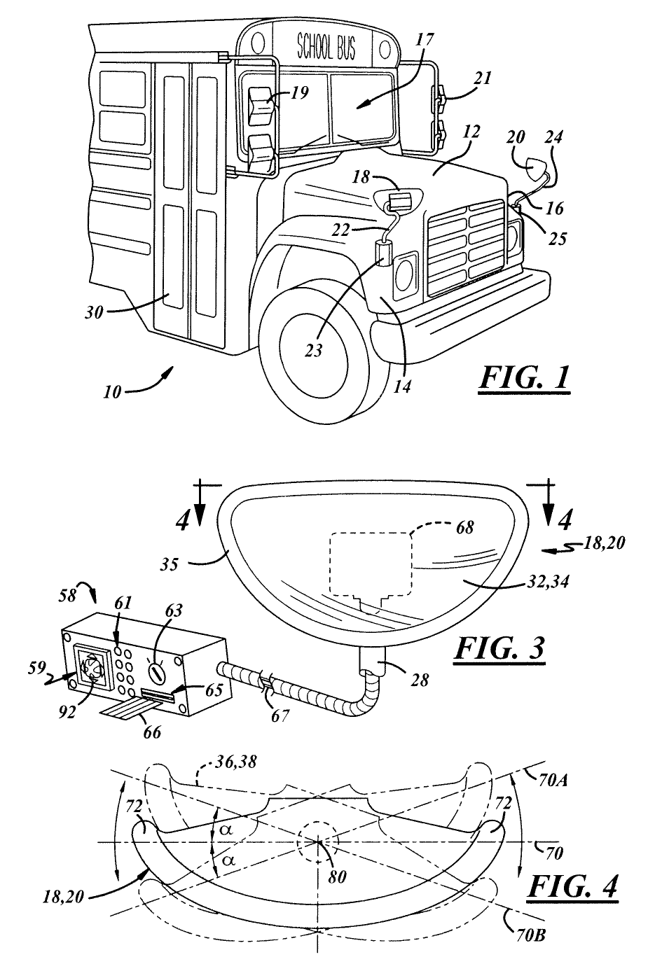

Referring to FIG. 1, a school bus 10 has a hood 12 and two front fenders 14 and 16. The hood 12 often causes a large area in front of the school bus to be hidden from direct view of the driver sitting in the cab area 17 of the bus, particularly in view of its height from the ground. Heretofore, children have been injured or killed when standing in this area as the bus moves forwardly.

The school buses have conventional side rear view “driving” mirrors 19, 21 mounted on the two sides of the bus, but these are insufficient to show the blind spots in front of the bus and immediately along its sides.

To address these problems, crossview mirror assemblies 18 and 20 are mounted on the fenders 14 and 16. The mirror assemblies 18 and 20 are supported and mounted on the fenders by mounting assemblies 22 and 24. The mirror assemblies are positioned so that the bus driver in the cab area can clearly see the hidden area in front of the school bus 10 and the areas alongside the school bus 10, particularly along the side opposite the driver and with the passenger door 30. Preferably, the mirror assemblies 18 and 20 are also mounted such that the “blind spot” behind each mirror assembly is fully disclosed in the other mirror.

Each of the mirror assemblies 18 and 20 are preferably the same with the same fields of view. However, they may take on a variety of different configurations and do not have to be the same in order to come within the scope of the present invention. The mirrors 18 and 20 are preferably of the type shown more particularly in FIGS. 3-6, and include elongate, arcuate mirror lens members 32 and 34, each having a reflective surface and a generally convex shape. The mirror lenses 32 and 34 are mounted in base members (or frame members) 36, 38. The mirror lens members and base members are glued or otherwise fixedly secured together. Gasket members 35 typically made of an elastomeric material are used to cover and seal the joints between the lens members and base members.

Mirror assemblies which can be used as cross view mirrors are shown, for example, in U.S. Pat. Nos. 5,589,984 and 6,293,679.

For safety reasons, all school buses in the United States are required to have a pair of crossview mirrors. Due to the significant number of injuries and deaths to children riding school buses, the U.S. Congress passed a law which mandated such mirrors. That law is Section 571.111 of the Federal Motor Vehicle Safety Standards (FMVSS).

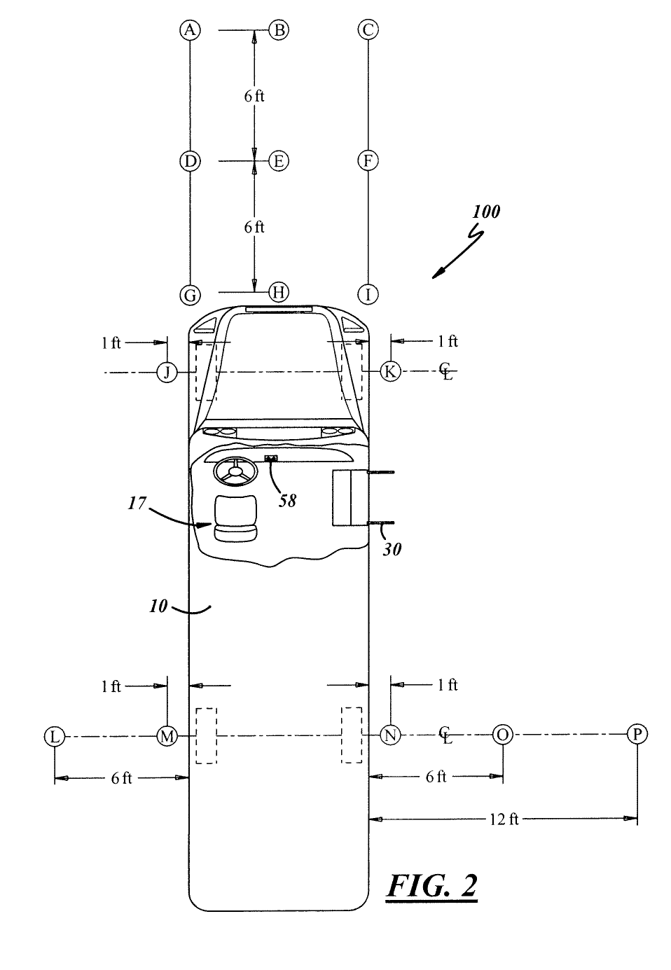

FMVSS Section 571.111 sets out the standards for the field of view and the image sizes that are required of crossview mirrors. The law also outlines an alignment procedure using cylinders or cones having certain heights and positioned at certain locations around the bus. The FMVSS crossview mirror alignment grid is schematically shown in FIG. 2 and referred to generally by the reference numeral 100.

Section 571.111(S13) specifies that sixteen objects (called “cylinders”) should be positioned around a bus. The cylinders are to be positioned at the locations A-P specified in FIG. 2. Cylinders A-O are each one foot in height. Cylinder P is three feet in height. The distances set forth in FIG. 2 between the cylinders and the bus are the distances specifically set out in Section 571.111 (S9, S13).

For purposes of describing the present invention, the “cylinders” will sometimes be referred to generally as “posts,” or visual objects. The cylinders can be cones, right cylinders, or any other structural object which can perform the same purposes and be used in an FMVSS alignment grid.

Once the bus is positioned in the crossview mirror alignment grid and the cylinders (“posts”) are positioned at the specified locations, the crossview mirrors are adjusted according to the eyes of a person sitting in the driver's seat. Initially, under Section 571.111, the driver's eye location is the location of a 25^{th} percentile adult female when seated in the driver's seat. In accordance with the present invention, however, it is possible to tune the positions and image views to particular drivers.

In general, in order to meet the Federal specifications, the mirrors must have a certain field of view and display reflected images of a certain size. In particular, the images reflected by the crossview mirrors must show the entire top surfaces of certain of the cylinders A-P and the images also must be of certain sizes and at certain positions in the reflected image.

For purposes of the record, Paragraphs S9 and S13 of FMVSS Section 571.111 are reproduced below:

The alignments of the crossview mirrors are initially set by the bus manufacturer who has to certify that the mirrors are properly aligned. Then once the school buses are delivered to the actual users, such as local school districts, the crossview mirrors must repeatedly be checked to make sure that they are maintained in the proper position and reflect the appropriate size images and fields of view. Misalignment of crossview mirrors can occur in many ways, such as when they are struck by bushes or branches, when jarred or jostled out of position by road conditions, or when touched or moved by someone whether inadvertently or intentionally. It is important for the safety of the school children to make sure that the crossview mirrors are properly aligned at all times.

Most school districts or school systems have crossview alignment grids that are patterned after the FMVSS standards and used to retest and renew the alignment of crossview mirrors on their school buses. Preferably, each school bus is tested every day before it is used.

During those alignment tests, the buses are driven onto the alignment grid and the images reflected by the crossview mirrors are checked. This procedure utilizes two persons, namely a first person, such as the driver, who is positioned inside the bus, and a second person standing outside the bus who can manually make the appropriate adjustments as requested by the first person. This is a time consuming procedure and requires additional cost and manpower that few school districts can afford.

With the present invention, the crossview mirrors can be adjusted quickly and easily—and by only one person. The crossview mirrors are adjusted by remote control solely by the person (driver) sitting in the driver's seat inside the cab of the bus. Assistance by another person is not required. Checking for misalignments and making the necessary realignments are accomplished in a faster and easier manner. After the bus is driven onto the crossview alignment grid at a bus storage yard or the like, the field of view and image sizes are checked, and any necessary adjustments to the alignments are made remotely.

The mirror assemblies are electronically actuated by a remote control system. The system can adjust the mirror horizontally, or vertically, or both. One preferred system only allows mirror assembly adjustment horizontally in a clockwise or counterclockwise direction.

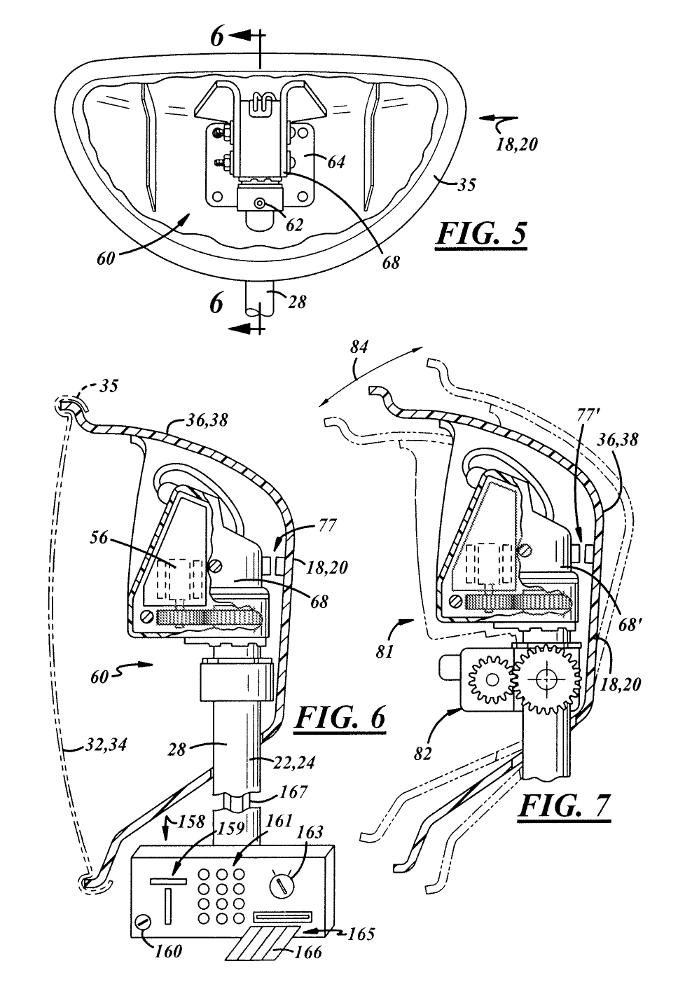

One preferred remote control system is shown in FIGS. 3-6. As best seen in FIGS. 5 and 6, the mounting assembly 22 preferably includes a tubular member 28 attached to, or extending through, the base member 36. The mounting assemblies include mounting brackets 23, 25 which secure the mirror assemblies to the bus (see FIG. 1). Inside the mirror assemblies, the tubular member 28 is secured to a mounting clamp 60 via a bolt 62 or some other suitable fixation device. The mounting clamp 60 is preferably made of a plastic material, such as nylon, and has a base portion 64 that seats an electronic actuator 68.

The electronic actuator 68 is seated on top of the tubular member 28. Brackets are affixed to the base member 36 and extend outwardly where they receive a bolts or other fastening members that secure the brackets to the electronic actuator 68.

The electronic actuator 68 is coupled to an electronic controller (shown as 58 in FIGS. 3 and 158 in FIG. 6) contained within the cab area 17 of the vehicle 10. Electric leads 67 and 167 connect the controller to the mirror assemblies. The leads 67, 167 are preferably extended through the hollow mounting support 28 and within the hood 12 of the vehicle 10 to the cab area 17. The electronic controllers 58, 158 are contained within the dashboard region of the cab area 17 and within easy access of the driver of the vehicle 10. Power to the controller can be from the vehicle battery or electrical system.

Although a variety of electronic controllers 58, 158 are contemplated, in one embodiment the electronic controllers 58, 158 may include a directional control button interface 59 (see FIG. 3) or a dial interface 159 (FIG. 6) that allows a user within the cab area 17 to adjust the mirror assembly positioning. Other mechanisms for operating the movements of the mirror assemblies are possible within the skill persons in the art.

Each mirror assembly 18, 20 is mounted to the respective fender 14, 16 so that the reflective lens members 32 and 34 have at least a fixed up and down visual orientation (along the y-axis or vertical adjustment). However, through use of the coupled electronic controller 58, 158 and electronic actuator 68, complete electronic adjustment of the mirror assemblies 18, 20 rightward or leftward (corresponding to a counterclockwise or clockwise adjustment, (i.e., horizontal adjustment) of the mirror assembly) is obtained by the operator within the cab area 17 without the need for external assistance. This allows complete field of vision to the area in front and to the sides of the bus 10 for any vehicle operator.

To accomplish this counterclockwise or clockwise adjustment about a horizontal plane, the electronic controller 68 is used by the operator in the cab area 17 to control the electronic actuator 56 that adjusts the mirror assemblies 18, 20 in a rightward and leftward direction. Although a variety of electronic controllers 58, 158 are contemplated, in one embodiment the electronic controllers 58, 158 may include a directional control button interface 59 (see FIG. 3) or a dial interface 159 (FIG. 6) that allows a user within the cab area 17 to adjust the mirror assembly positioning. Additionally, it is contemplated that the electronic controllers 58, 159 include one or more position storage buttons 61, 161 that allow for the electronic storage of a particular mirror position within the system. It is contemplated that a plurality of position storage buttons 61, 161 may be utilized such that the mirror position may be personally optimized for a plurality of drivers and their unique settings may be implemented through the selection of a position storage button 61, 161 assigned to them. This allows the mirror position on the bus to be optimized for a plurality of drivers and allows the drivers to quickly and easily reset the mirror position into their personalized position upon entering the vehicle. Additionally, should the mirror become dislodged during operation of the bus 10, the mirror can be easily reset by way of the selection of the position storage button 61, 161 to the previously optimized position. A position sensor 77 mounted within said mirror assembly 18 may be utilized to determine precise repositioning.

It is further contemplated that the position storage buttons 61, 161 may include labeled buttons associated with a driver's sitting height rather than for a specific driver. In this embodiment, optimal mirror positioning may be pre-assigned for a range of driver sitting heights. Individual drivers may then simply be measured for their particular “sitting height” and may select the appropriate height from the position storage buttons 61, 161 upon entering the vehicle.

Additionally, it is contemplated that the electronic controllers 58, 158 may optionally include a locking control 63, 163 and/or a driver identification key element 65, 165. The locking control 63, 163 would preferably comprise a switch that would prevent mirror movement from the optimized position once activated. This may be utilized in combination with a mirror position sensor 167 (FIG. 6) such that if the mirror assembly is dislodged, it will automatically reset itself to the optimized position when the locking control 64, 163 is activated. The driver identification key element 65, 165 may be utilized in place of the position storage buttons 161 and may represent a physical key or a keycard slot. In one preferred embodiment, a driver would insert his keycard 66, 166 containing information relative to optimized mirror position or sitting height in order to calculate such an optimized position. While a card is inserted, the electronic controller 58, 158 positions and/or keeps the mirror in the optimized position relative to the particular driver.

As best shown in FIG. 4, the electronic actuator 68 can pivot, or swivel, clockwise or counterclockwise about a horizontal plane in response to an electronic signal sent from the electronic controller 68 via electric leads 60. The actuator 68 pivots about a center point 80 defined by the length of the tubular portion and mounting support, which remain stationary. The pivoting of the electronic actuator 68 in turn causes the coupled arcuate mirror assembly to pivot in response. The amount of horizontal pivoting of the mirror assembly 20, 22 about the center point 80 is restricted in an about horizontal plane direction internally within the actuator 68 to an amount corresponding to a predetermined angle “α”. The angle “α” is a comparison of the relative orientation of the mirror assembly along a vertical plane 70 in a first position, corresponding to a centered position, and a second position, corresponding to a counterclockwise most pivoted position defining a vertical plane 70A, or clockwise most pivoted position defining a vertical plane 70B.

The planes 70, 70A, 70B, as shown in FIG. 4, are defined as by a vertical plane extending from the corners 77, or outermost edges, of the curved back plate 30 through the center point 80. Preferably, the complete range of angle “α” is limited to about 45 degrees when comparing the mirror assembly 22 in the centered position with either the counterclockwise most or clockwise most position.

The electronic actuator 68 describes any type of remotely controllable electronic motor that can swivel, or otherwise rotate, clockwise or counterclockwise about a horizontal plane about a fixed vertical center point 60 as will be understood by one of skill in the art. One preferred electronic actuator 68 (shown in FIGS. 5 and 6) and electronic controller 58 (shown in FIG. 3) combination that meets these requirements is a servomotor 56 electronically coupled to a toggle switch type controller 58. In this embodiment, the depressing of the toggle switch 92 by the operator in a leftward or rightward direction within the cab area 17 induces an electronic signal to be sent to the servomotor. The servomotor 56 interprets the electronic signal and generates a direct current within its coupled magnetic coils (not shown) in response to the electronic signal. The direct current creates a magnetic field that induces a shaft portion (not shown) of the servomotor 56 to rotate clockwise or counterclockwise in response to the magnetic field. The arcuate mirror 26 and mirror assembly 22 are then adjusted rightward or leftward in response to the rotation to improve the field of vision in front of and to the side of the vehicle 10.

The movement clockwise or counterclockwise is limited in two distinct ways. First, the operator may simply return the toggle switch 92 to its normal position if the mirror adjustment is satisfactory. Second, the servomotor 56 itself may have a limiter to restrict the clockwise or counterclockwise rotation of the mirror assembly 22 as described above corresponding to angle α.

Another preferred electronic actuator 68 that may be used is a stepper motor electronically coupled to an appropriate controller (shown as 158 in FIG. 6). Most steppers, as they are also known, can be stepped at audio frequencies, allowing them to spin quite quickly. With an appropriate controller, such as a dial controller 160, the mirror assemblies may be started and stopped “on a dime” at controlled orientations. Thus, in this preferred embodiment, the operator turns the dial of dial controller 160 clockwise or counterclockwise to a desired position. An audio signal is sent to the stepper motor as a function of the dialed position. The stepper motor receives the audio signal and rotates clockwise or counterclockwise to a precise location in response to the audio signal. As one of ordinary skill appreciates, the controller 158 itself has a built in rotation-limiting feature that is dependent upon the number of allowable dial positions. Of course, while the preferred embodiments as described above in FIGS. 5 and 6 represent two preferred actuators and controllers for controlling the movement of the mirror 26, any number of other types of actuator devices may be utilized.

Another embodiment of the invention provides crossview mirror assemblies that can be adjusted vertically upwards and downwards around a horizontal axis. A representative mechanism and system for accomplishing this is shown in FIG. 7 and generally referenced by the numeral 80. Other actuators which can move or rotate members around two axes are known in the art and any conventional mechanism which can do this can be utilized.

In FIG. 7, the components that are the same as those described above are marked with the same reference numbers followed by a prime. The adjustment mechanism 81 has a first part 68′ which is the same as mechanism 68 described above. This part 68′ is used to adjust the mirror in a horizontal manner around a vertical axis. The mechanism 81 also has a second part 82 which is used to adjust the mirror in a vertical direction around a horizontal axis. The mechanism 82 is positioned on the end of tubular member 28′ and, when electronically activated, rotates the mirror assemblies 18′ and 20′ in the direction 84 (as shown by arrow 84).

The present invention addresses problems with typical crossview mirrors found in the prior art by allowing the arcuate mirror 26 to be adjusted as seen by the operator of the bus 10 while inside the bus to ensure the minimization of blind spots in front of and along the side of the vehicle 10. This adjustment takes place within the cab area 17 of the vehicle 10. Thus, additional personnel are not required in aiding to adjust the mirrors. Properly adjusted mirrors will add greater safety to the children who ride the bus every day.

The remote control adjustment and realignment system in accordance with the present invention has another possible use and benefit. If, for example, one or both of the crossview mirrors become significantly misaligned during use of the bus, the driver can stop the bus and adjust the crossview mirrors himself or herself back to approximately where they should be. Then, when the bus is returned to the storage lot, the mirrors can be precisely realigned in an alignment grid.

While the invention has been described in terms of preferred embodiments, it will be understood, of course, that the invention is not limited thereto since modifications may be made by those skilled in the art, particularly in light of the foregoing teachings.

What is claimed is:

1. A method of adjusting crossview mirrors on a bus, the bus having crossview mirrors mounted thereon, said method comprising the steps of:
positioning the bus in an alignment grid system having a plurality of post members, said post members being positioned at least one location corresponding to FMVSS Sec. 571.111 (S9);
adjusting the crossview mirrors in compliance with the standards of FMVSS Sec. 571.111 (S9) and (S13);
said crossview mirrors being adjusted electronically remotely from inside the bus.

2. The method of claim 1 wherein said crossview mirrors are adjusted by a person positioned on a driver's seat inside the bus.

3. A method for improving the field of vision of a crossview mirror assembly in front of and to the side of a school bus, the crossview mirror assembly having an arcuate mirror and being mounted to the front fender of the vehicle using a mounting support, the method comprising:
coupling an electronic actuator within the crossview mirror assembly to the arcuate mirror;
coupling an electronic controller within a cab area of the vehicle;
electronically coupling said electronic actuator to said electronic controller; and
activating said electronic controller to send an electrical signal to said electronic actuator, said electronic actuator interpreting said electronic signal and rotating in a first direction about the center point about a horizontal plane in response to said interpreted electronic signal, thereby rotating said coupled arcuate mirror in said first direction about said horizontal plane about the center point, said first direction selected from the group consisting of a clockwise direction and a counterclockwise direction.

4. The method of claim 3, wherein the rotation of said actuator is limited to a predetermined angle about said center point relative to a centered position, wherein said predetermined angle is a defined as a comparison of a relative orientation of said arcuate mirror at a first position as compared with said centered position, said first position corresponding a counterclockwise-most allowable position or to a clockwise-most allowable position of said arcuate mirror and said centered position located midway between said counterclockwise-most allowable position and said clockwise-most allowable position.

5. The method of claim 4, wherein said predetermined angle is between approximately 0 and 45 degrees clockwise or counterclockwise about said horizontal plane from said centered position.

6. The method of claim 4, wherein coupling an electronic actuator and coupling an electronic controller comprises:
coupling a servomotor within the crossview mirror assembly to the arcuate mirror; and
coupling a toggle switch type controller within a cab area of the vehicle.

7. The method of claim 6, wherein activating said electronic controller comprises:
depressing a toggle switch of said toggle switch type controller in a first direction, wherein said depression sends an electrical signal to said electronic actuator, said electronic actuator interpreting said electronic signal to rotate about the center position along a horizontal plane as a function of said interpreted electrical signal, thereby rotating said coupled arcuate mirror in said first direction about the center point, said first direction selected from the group consisting of a clockwise direction and a counterclockwise direction.

8. The method of claim 4, wherein coupling an electronic actuator and coupling an electronic controller comprises:
coupling a stepper motor within the crossview mirror assembly to the arcuate mirror; and
coupling a dial controller within a cab area of the vehicle, said dial controller having a dial rotatable between.

9. The method of claim 8, wherein activating said electronic controller comprises:
dialing said dial from a first position to a second position, thereby generating an audio signal;
sending said audio signal from said dial controller to said stepper motor, wherein said stepper motor rotates in a first direction from a first position to a second position about a center point along a horizontal plane in response to said audio signal.

10. The method of claim 9, wherein said first direction is a counterclockwise direction.

11. The method of claim 9, wherein said first direction is a clockwise direction.

12. The method of claim 3 further comprising parking the school bus in a grid pattern of objects positioned in accordance with FMVSS Section 571.111, and
adjusting the crossview mirrors as required in order to comply with FMVSS Section 571.111.
